(19) United States
(12) Patent Application Publication
(10) Pub. No.: US 2010/0090657 A1
(43) Pub. Date: Apr. 15, 2010

(54) CIRCUIT ARRANGEMENT FOR THE PARALLEL OPERATION OF BATTERY CHARGERS

(76) Inventor: Andras Fazakas, Budapest (HU)

Correspondence Address: FITCH, EVEN, TABIN & FLANNERY, P. O. BOX 18415, WASHINGTON, DC, 20036, US

(21) Appl. No.: 12/597,441

(22) PCT Filed: Apr. 24, 2008
(86) PCT No.: PCT/HU08/00040

§ 371 Date: Oct. 23, 2009

(30) Foreign Application Priority Data
Apr. 24, 2007 (HU) P0700301

(51) Int. Cl. H02J 7/04

(52) U.S. Cl. 320/145

(57) ABSTRACT

Circuit arrangement for the parallel operation of battery, wherein each battery charger comprises respective pairs of direct current output terminals for connection to the battery to be charged, and between said pairs of output terminals a repetitive sequence of pulsating direct current voltage can be measured, and the peak values of the pulsating direct current voltage is higher than the nominal terminal voltage of the battery (B), and each battery charger (Ch1, Ch2, . . . Chn) comprises in series with the current path at least one electrolytic capacitor (C1, C2, . . . Cn), an inductance (L1, L2, . . . Ln) and at least one semiconductor means (D1, D2, . . . Dn) open in the direction of the charging current, the output terminals of the battery chargers are connected in parallel with each other and for each of the battery chargers (Ch1, Ch2, . . . Chn) it is true that in the respective charging periods the vectorial sum of the instantaneous voltages on the electrolytic capacitor (C1, C2, . . . Cn) and on the inductance (L1, L2, . . . Ln) reaches the momentary terminal voltage of the battery at least for the duration of a charging period defined by the actual voltage of the battery (B) to be charged, and during the charging period or a part thereof the discharging current of the electrolytic capacitor (C1, C2, . . . Cn) in the particular battery charger flows in the battery (B) to be charged.

The invention relates to a circuit arrangement for the parallel operation of battery chargers each designed for respective predetermined charging power and fed from an alternative current mains supply, wherein each of the battery chargers comprise respective pairs of direct current output terminals for connection to the battery to be charged, and between the pairs of output terminals a repetitive sequence of pulsating direct current voltage can be measured, wherein the pulses of the sequence occur corresponding to the pulses of the feeding alternative current, and the peak values of the pulsating direct current voltage is higher than the nominal terminal voltage of the battery to be charged.

For users operating a higher number of batteries a difficulty arises from the need of using battery chargers designed for charging power required to be in correspondence with the charge storage capacity of the batteries used. Manufacturers of battery chargers sell battery charger types with different power ratings. At the users the required overall charging power often changes, and there is no practical solution how to increase the available charging power by the parallel connection of available battery chargers or such solutions have several limitations.

The reason of such difficulties in combining the power of several individual chargers can be easily understood, since classic battery chargers are designed as direct current voltage generators, wherein the terminal voltage changes with load within a narrow range. The power that can be obtained from a battery charger is basically determined by the voltage difference between the nominal output voltage of the battery charger and the actual terminal voltage of the battery under charge. If the battery voltage is higher than the nominal output voltage of the charger circuit, then the charging current will rapidly decrease and in a reverse situation the charging current will rapidly increase.

If e.g. for the charging of the battery a power of 10 kW is required and this power is provided the parallel connection of three chargers with rated powers 5 kW, 3 kW and 2 kW, respectively, then it must be ensured that the voltage-to-current curves of all the parallel connected chargers be identical. If any of the chargers gets overloaded and cannot supply the current proportionally assigned thereto, then the other chargers will also be overloaded and will stop their operation or get destroyed.

Battery chargers with voltage generator design can be connected in parallel only in a temporary manner if appropriate inspection and control circuits are additionally used, which property imposes a serious limitation against the flexible use of the chargers, and owing to the need for a sophisticated control the investment costs will be higher.

In U.S. Pat. No. 7,135,836 an example for the above described type of parallel connection of battery chargers has been described, wherein a master control unit is used to inspect the respective chargers being all adjusted by the master control circuit in accordance with the measured charging parameters. In this circuit arrangement the charger circuits used have all identical rated powers and designs, and the output terminals of the chargers are connected in parallel through controlled switches and only for time periods defined by the control and not in a permanent way as one would expect on the basis of the description that refers to their parallel operation.

Further battery charger circuits are known which have internal design that cannot be regarded to belong to the voltage generator type chargers. In the battery charger circuits described in the international publication WO 01/06614 the momentary charging voltage was provided by the vectorial sum of the energies of a charged capacitor and an energized inductance. This energized inductance was realized by the secondary winding of a mains transformer. The circuit utilizes both half periods of the alternating mains voltage, and has provided a specific charging process with high output current. The fact that one component of the output voltage is constituted by the voltage of one or more capacitance has made the charging process flexible, because any possible short-circuit of the battery to be charged cannot damage the operation of the circuit and the terminal voltage of the battery can control the charging process in an appropriate way.

Similar further battery charger circuits have been described in my three co-pending patent applications entitled: “Battery charger circuit”, “Battery charger operated from a three-phase mains” and “Battery charging circuit for charging two batteries”. These charging circuits are similar to the design of this publication because in series with their charging current path lines they comprise one or more electrolytic capacitors with predetermined charge and an appropriately energized inductance, preferably the secondary winding of a transformer and at least one diode.

The object of the invention is to provide a circuit arrangement for the parallel connection of battery charger circuits, wherein the respective charger circuits contribute to the charging process according to their specific rated powers, and wherein the aforementioned problems coming from the parallel connection of the charger circuit will not take place.

For attaining this objective I have realized that the above described problems of conventional battery chargers are associated with the design of such chargers as voltage generators and therefore they cannot be fully eliminated. According to the invention I have realized that in case of battery chargers that comprise an electrolytic capacitor and an inductance in the main charging circuit the value of the output voltage can only control the charging process but will not limit this process in the extent as it occurs in case of battery chargers built according to the voltage generator principle. In battery chargers of the former design i.e. that comprise the capacitor in series with the inductance, the voltage of the battery under charging keeps the output voltage constant in the short charging periods, therefore by the extent the voltage measurable on the inductance (i.e. on the secondary winding of the transformer) increases, the voltage on the charged capacitor will decrease, whereas the extent of the charging current will be determined by the combined effect of the charge loss suffered by the capacitor and the transformed energy of the inductance.

Battery chargers of the aforementioned design will therefore “pump” their charging energies in the battery during their associated charging periods. In the charging periods the batteries can be regarded as linear devices, wherein the battery voltage cannot change within a full or half period of the alternative mains supply (e.g. within 20 ms or 10 ms). The respective charging currents of the parallel connected battery chargers will be superimposed on each other (if their respective charging periods cover or overlap each other), therefore these battery chargers will operate as being independent from each other.

In view of the above and by utilizing the afore described properties a circuit arrangement has been provided by the present invention for the parallel operation of battery chargers each designed for respective predetermined charging power and fed from an alternative current mains supply, wherein each of the battery chargers comprise respective pairs of direct current output terminals for connection to the battery to be charged, and between the pairs of output terminals a repetitive sequence of pulsating direct current voltage can be measured, wherein the pulses of the sequence occur corresponding to the pulses of the feeding alternative current, and the peak values of the pulsating direct current voltage is higher than the nominal terminal voltage of the battery to be charged, and according to the invention each of the battery chargers comprises in series with the current path interpreted in the direction of flow of the charging current at least one electrolytic capacitor of high capacitance value, an inductance and at least one semiconductor means open in the direction of flow of the charging current, the output terminals of the battery chargers are connected in parallel with each other and for each of the battery chargers it is true that in the respective charging periods the vectorial sum of the instantaneous voltages on the electrolytic capacitor and on the inductance reaches the momentary terminal voltage of the battery at least for the duration of a charging period defined by the actual voltage of the battery to be charged, and during this charging period or a part thereof the discharging current of the electrolytic capacitor in the particular battery charger flows in the battery to be charged.

The simplest way of supply occurs from the mains line. A different supply can be e.g. in vehicles by using the existing AC generator in the vehicle for the required supply.

From the point of view of both the distribution of the mains load and the smooth charging it is preferable if the battery chargers are fed from different phase lines of a multi-phase mains supply.

The actual battery charging tasks can be solved in an easier way at a user if the user has battery chargers with different nominal charging powers which can be interconnected according to the actual charging power demands.

The interconnection should be made so that the number of the parallel connected battery chargers is chosen to create a balance between the sum of the nominal charging powers of these battery chargers and the charging power required for charging the battery, wherein the sum of the powers should be higher than the required charging power or at least equal therewith.

The energy stored in the capacitors will be sufficient if the capacitance of each electrolytic capacitor is higher than 100 μF and preferably can reach a few thousand when the frequency the alternative current mains supply is around 50/60 Hz. With increasing frequency the minimum capacitance can be decreased proportionally.

The selection of the appropriate capacitance may occur if the battery charger comprises at least one further electrolytic capacitor of similarly high capacitance value and a controlled semiconductor switch that connects this at least one further electrolytic capacitor in parallel with the first electrolytic capacitor.

The charging process realized by such battery charger circuits is independent from the way how these chargers are supplied, and it is also possible that different ones of the parallel battery chargers are fed from different alternating current mains supplies operating with differing frequencies. By such a solution a battery charger supplied e.g. from the mains line can be connected in parallel with an other battery charger supplied from a generator driven by a local motor, and this second battery charger will be switched to operation if the required charging energy is higher than the power that can be taken from the available mains line.

The invention will now be described in connection with preferable embodiments thereof, wherein reference will be made to the accompanying drawings.

In the drawing:

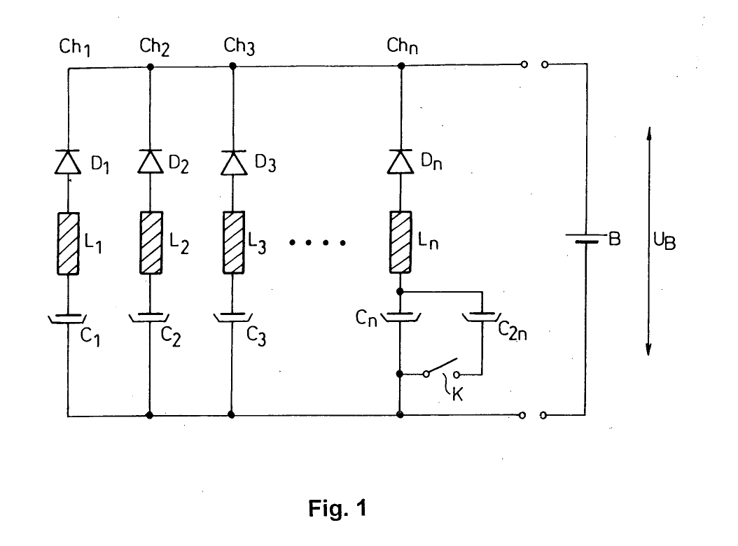

FIG. 1 shows the schematic circuit diagram of several battery chargers connected in parallel; and

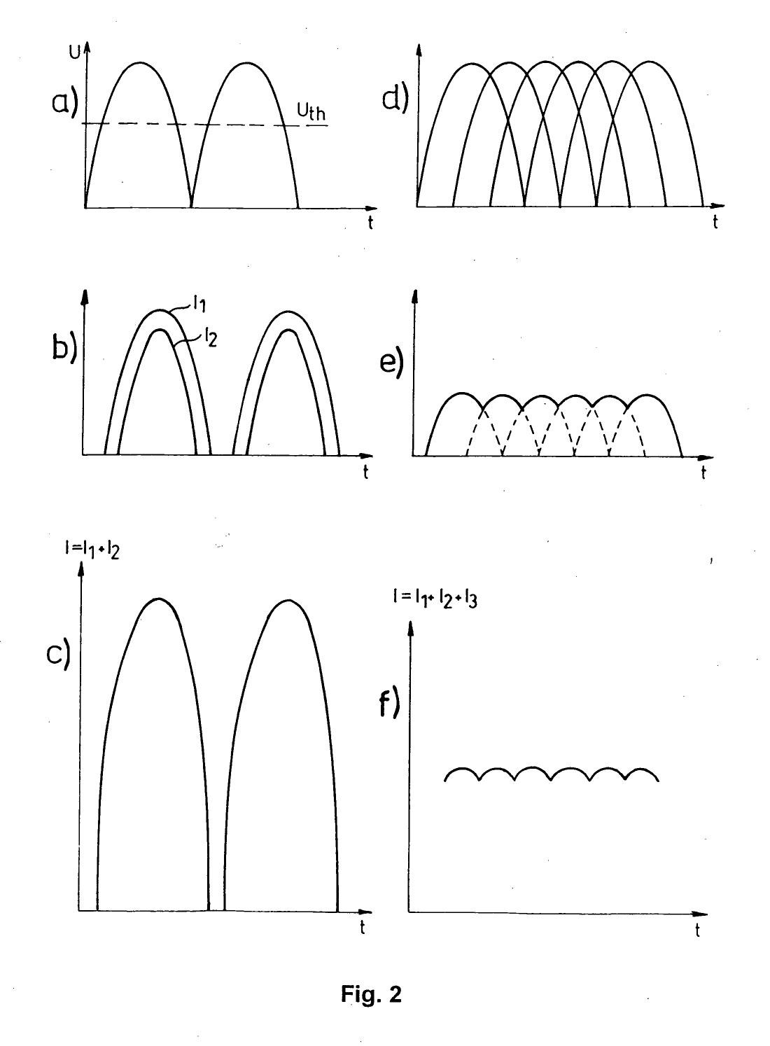

FIG. 2 shows time curves being characteristic to different charging versions.

FIG. 1 shows n pieces of separate battery chargers Ch1, Ch2, Ch3, . . . , Chn, and each of them is designed internally e.g. as it is shown in FIG. 7 of the above referred international publication WO 01/06614, and the chargers generate respective consecutive pairs of charging pulses in each period of the alternating mains voltage towards the battery which is charged. For the sake of better visualization the battery chargers Ch1, Ch2, Ch3, . . . , Chn have been schematically illustrated by components arranged in their main charging circuit, i.e. by electrolytic capacitors C1, C2, C3, . . . Cn that have high capacitance values (e.g. above 100 g), by series inductances L1, L2, L3, . . . Ln by diodes D1, D2, D3, . . . Dn being all forward biased by the charging current. If e.g. the battery charger Ch1 is compared with the circuit shown in FIG. 7 of the above referred publication, then the capacitor C1 of present FIG. 1 corresponds to the series resulting capacitor C1 or C2 of that FIG. 7, and the inductance L1 corresponds to the inductance of the secondary winding of the transformer Tr whose voltage is generated by the transformed energy. Diode D1 is the forward biased ones of the bridge connected in a Graetz circuit. Generally two electrolytic capacitors and two diodes are connected in parallel with the inductance, but for the sake of better illustration these elements have been represented by a single component in the drawing.

FIG. 1 shows that the outputs of the battery chargers Ch1, Ch2, Ch3, . . . , Chn are simply connected in parallel with each other and coupled directly to the battery B to be charged.

It is stated that this parallel connection can be realized without any difficulty and the problems described in detail in connection with the battery chargers designed as voltage generators will not appear. The operation is described in connection with the time curves of FIG. 2.

Although each of the above referred battery chargers generates current pulses that change in time as described in detail in the cited publication, wherein both the shape and intensity of the pulses depend on the terminal voltage Ub of the battery B to be charged, the time curves of FIG. 2 show simplified current pulses instead of the exact waveforms because for understanding the present invention it is not necessary to exactly know the actual curves.

Diagram a. of FIG. 2 shows the waveform of the rectified mains voltage as transformed to the inductance L1 of the battery charger Ch1, wherein a full wave rectification was used. In case of a mains having 50 Hz frequency the full period (two half periods) lasts 20 ms. If the voltage of the battery charger Ch1 is appropriately adjusted, the batter charger Ch1 delivers charging current pulses when the rectified mains voltage is higher than a threshold level Uth. The output current pulse of the battery charger Ch1 is shown in diagram b. of FIG. 2 as pulse I1. Let us suppose that the second battery charger Ch2 generates its own output current pulse when the first battery charger Ch1 but it has a smaller power, thus the pulse I2 generated thereby has a smaller intensity than the pulse I1. During the chosen period of the mains voltage these pulses will appear twice and their width (duration) is smaller than the duration of the half period.

The terminal voltage Ub of the battery B cannot change during the chosen short period of 20 ms (since the charging process of the battery B is a very slow process compared to the period time, it can take even several hours) furthermore the partially charged battery B is a linear element which means that it can receive unlimited amount of charging current (within the given range), thus the current pulses I1, and I2 of the battery chargers Ch1 and Ch2 will equally flow towards the battery B (to charge the same) as if they would charge the battery alone i.e. without the presence of the other battery charger. Diagram c. of FIG. 2 shows the current I that charges the battery B, which is: I=I1+I2, thus it can be understood that each of the battery chargers Ch1 and Ch2 supplies its own rated power to the battery. The same linear addition is obtained if further battery chargers Ch3 . . . Chn are connected in parallel with the parallel group of the first and second battery chargers Ch1 and Ch2.

In the case of using battery chargers with voltage-generator type design the problem lied in that the voltages UL1 and UL2 appearing on the inductances L1 and L2 were different, therefore either an equalizing current started to flow between them or only the source with the higher voltage could be used for charging, and the other battery charger (with the smaller voltage) did not work. In case of the present invention the voltage balance is automatically ensured by the presence of the electrolytic capacitors C1 and C2. The voltage on these capacitors C1, C2 changes in such a way that the equation: UC1+UL1=Ub=UC2+UL2 remains always true. In the equation the forward bias voltage UD1 of the diode D1 (which is typically 0.3-0.5 V, in case of two seriously connected diodes the twice) was not taken into account, but in case of accurate calculations this should also be considered. In view of the fact that at the starting instance of the charging process the capacitor C1 was already charged (which initial charge was provided by the charging circuit during the time elapsed between the charging pulses), the energy stored therein is added to the energy of the charging pulse I1. The general equation of the system will be:

UC1+UL1=UC2+UL2=UC3+UL3= . . . =UCn+ULn.

The charging process will be smoother an more uniform if the battery chargers Ch1, Ch2, Ch3 are supplied from alternative mains voltage lines fed from respective phases of a three-phase mains supply. Diagram d. of FIG. 2 shows such a feeding, wherein 2×3 half periods can be seen, each being shifted by 120° from the previous one, and this also means that the charging pulses I1 . . . I3 overlap each other in time. The battery B will be charged by a resulting pulse I=I1+I2+I3 as shown in diagram f. of FIG. 2 being a slightly pulsating but never disappearing current.

It should be noted that the charging process is also controlled by the slowly changing terminal voltage Ub of the battery B. In addition to this automatic regulation the charging process can be controlled by several other ways, and such possibilities are described in detail in the cited patent publication relating to the charging circuits. Of these possibilities an expedient one should be mentioned, i.e. that the capacitance value of the electrolytic capacitors with high capacitance (e.g. above 100 μF) can be changed by inserting (or removing) further electrolytic capacitors in parallel therewith. This possibility as illustrated in FIG. 1 in connection with the last battery charger Chn, wherein by means of a semiconductor switch K parallel to the capacitor Cn1 another capacitor Cn2 (and in case of need further capacitors) can be connected. The design of the semiconductor switch can be e.g. as described in the international publication WO 2005/07888, wherein a series inductance limits the rising steepness of the current.

The fact that the parallel connection of the individual battery chargers do not require any specific measure, does not mean that the slow charging process of the battery B cannot be controlled as the charging state thereof goes on and changes. The charging properties of the respective battery chargers can be varied independently, but preferably in a coordinated way.

By using the present invention larger battery users can realize practically unlimited charging power by using a comparatively small number of battery chargers with different power ratings. This is also a preferred solution from the point of view of the manufacturers of the battery chargers because battery chargers with higher power rating can be realized by the multiplication and parallel connection of smaller battery chargers. This may result in that the manufacturer has to make a larger series of battery chargers designed e.g. for a single power rating, whereby the unity cost of the battery charger will be smaller in view of the production in larger scale.

The present invention has created a many-sided variability for the users, whereby the required number of battery chargers (with different power ratings) can be reduced and temporary needs can be satisfied.

1. Circuit arrangement for the parallel operation of battery chargers each designed for respective predetermined charging power and fed from an alternative current mains supply, wherein each of said battery chargers comprise respective pairs of direct current output terminals for connection to the battery to be charged, and between said pairs of output terminals a repetitive sequence of pulsating direct current voltage can be measured, wherein the pulses of said sequence occur corresponding to the pulses of said feeding alternative current, and the peak values of said pulsating direct current voltage is higher than the nominal terminal voltage of said battery to be charged, characterized in that each of said battery chargers (Ch1, Ch2, . . . Chn) comprises in series with the current path interpreted in the direction of flow of the charging current at least one electrolytic capacitor (C1, C2, . . . Cn) of high capacitance value, an inductance (L1, L2, . . . Ln) and at least one semiconductor means (D1, D2, . . . Dn) open in said direction of flow of the charging current, said output terminals of said battery chargers are connected in parallel with each other and for each of said battery chargers (Ch1, Ch2, . . . Chn) it is true that in the respective charging periods the vectorial sum of the instantaneous voltages on said electrolytic capacitor (C1, C2, . . . Cn) and on said inductance (L1, L2, . . . Ln) reaches the momentary terminal voltage of the battery at least for the duration of a charging period defined by the actual voltage of the battery (B) to be charged, and during said charging period or a part thereof the discharging current of said electrolytic capacitor (C1, C2, . . . Cn) in said particular battery charger flows in said battery (B) to be charged.

2. The circuit arrangement as claimed in claim 1, wherein said battery chargers (Ch1, Ch2, . . . Chn) are fed from different phase lines of a multi-phase mains supply.

3. The circuit arrangement as claimed in claim 1, wherein said predetermined charging power is different for different ones of said battery chargers (Ch1, Ch2, . . . Chn).

4. The circuit arrangement as claimed in claim 1, wherein the number of the parallel connected battery chargers (Ch1, Ch2, . . . Chn) is chosen so as to create a balance between the sum of the nominal charging powers of said battery chargers and the charging power required for charging the battery (B), so that said sum should be higher than said required charging power or at least equal therewith.

5. The circuit arrangement as claimed in claim 1, wherein the capacitance of each of said electrolytic capacitors (C1, C2, . . . Cn) is higher than 100 μF in case the frequency of said alternative current mains supply is around 50/60 Hz.

6. The circuit arrangement as claimed in claim 1, wherein said battery charger (Chn) comprises at least one further electrolytic capacitor (Cn2) of high capacitance value and a controlled semiconductor switch (K) connecting said at least one further electrolytic capacitor (Cn2) in parallel with said electrolytic capacitor (Cn).

7. The circuit arrangement as claimed in claim 1, wherein said parallel battery chargers (Ch1, Ch2, . . . Chn) being fed from different alternating current mains supplies operating with differing frequencies.
